(19) United States
(12) Patent Application Publication
(10) Pub. No.: US 2018/0086255 A1
(43) Pub. Date: Mar. 29, 2018

(54) VEHICLE ILLUMINATED TRIM

(71) Applicant: Ford Global Technologies, LLC, Dearborn, MI (US)

(72) Inventors: Stuart C. Salter, White Lake, MI (US); Jeffrey Singer, Plymouth, MI (US); James J. Surman, Clinton Township, MI (US)

(73) Assignee: Ford Global Technologies, LLC

(21) Appl. No.: 15/278,378

(22) Filed: Sep. 28, 2016

(51) Int. Cl. B60Q 3/02; B60R 13/02; B60Q 3/00

(52) U.S. Cl. CPC B60Q 3/0266; B60R 13/0243; B60Q 2500/10; B60Q 3/008; B60Q 3/0293; B60Q 3/002

(57) ABSTRACT

A trim member for a vehicle is provided herein. The trim member includes a carrier structure. A decorative layer is coupled to the carrier structure forming a cavity therebetween. A protective layer is disposed over the decorative layer. A first plurality of beads is disposed within the decorative layer and contains a first photoluminescent structure therein. A second plurality of beads is disposed within the decorative layer and contains a second photoluminescent structure therein. A light source causes the first and second photoluminescent structures independently luminesce in response to an excitation light emitted by the light source.

### FIELD OF THE INVENTION

The present disclosure generally relates to vehicle lighting systems, and more particularly, to vehicle lighting systems employing one or more photoluminescent structures.

### BACKGROUND OF THE INVENTION

Illumination arising from the use of photoluminescent structures offers a unique and attractive viewing experience. It is therefore desired to implement such structures in automotive vehicles for various lighting applications.

### SUMMARY OF THE INVENTION

According to one aspect of the present disclosure, a trim member for a vehicle is disclosed. The trim member includes a carrier structure. A decorative layer is coupled to the carrier structure forming a cavity therebetween. A protective layer is disposed over the decorative layer. A plurality of beads is disposed within the decorative layer each containing a first or second photoluminescent structure therein. A light source is disposed within the trim member. The first and second photoluminescent structures independently luminesce in response to an excitation light emitted by the light source.

According to another aspect of the present disclosure, a trim member is disclosed. The trim member includes a carrier structure coupled to a decorative layer forming a cavity therebetween. A first set of beads is disposed within the decorative layer and contains a first photoluminescent structure therein. A light source extends a substantial portion of the carrier structure and is configured to progressively emit excitation light thereby causing the first photoluminescent structure to progressively luminesce along the trim member.

According to yet another aspect of the present disclosure, a trim member for a vehicle is disclosed. The trim member includes a carrier structure. A decorative layer is coupled to the carrier structure forming a cavity therebetween. A plurality of beads is disposed within the decorative layer. The plurality of beads contains a first or a second photoluminescent structure therein. A light source includes a plurality of LEDs that cause the first and second photoluminescent structures to independently luminesce in response to an excitation light emitted by the light source.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1A is a side view of a photoluminescent structure rendered as a coating for use in a photoluminescent latch assembly according to one embodiment;

FIG. 1B is a top view of a photoluminescent structure rendered as a discrete particle according to one embodiment;

FIG. 1C is a side view of a plurality of photoluminescent structures rendered as discrete particles and incorporated into a separate structure;

FIG. 2 is a perspective view of a decorative vehicle trim member installed in a vehicle door;

FIG. 3 is a perspective cross-sectional view of one embodiment the decorative vehicle trim member taken along the line III-III of FIG. 2;

FIG. 4 is a side cross-sectional view of one embodiment the decorative vehicle trim member taken along the line of FIG. 2;

FIG. 5 is an enlarged view of the area V of FIG. 4;

FIG. 6 is a perspective cross-sectional view of an alternate embodiment the decorative vehicle trim member taken along the line of FIG. 2;

FIG. 7 is a side cross-sectional view of the embodiment the decorative vehicle trim member of FIG. 6 taken along the line of FIG. 2;

FIG. 8 is a perspective cross-sectional view of an alternate embodiment the decorative vehicle trim member taken along the line of FIG. 2;

FIG. 9 is a side cross-sectional view of the embodiment the decorative vehicle trim member of FIG. 8 taken along the line of FIG. 2 having a light-producing assembly disposed therein;

FIG. 10 is an exemplary illumination sequence that may be implemented by the trim member; and

FIG. 11 is a block diagram showing the vehicle having the trim member therein operably coupled with one or more controls within the vehicle.

### DETAILED DESCRIPTION OF THE PREFERRED EMBODIMENTS

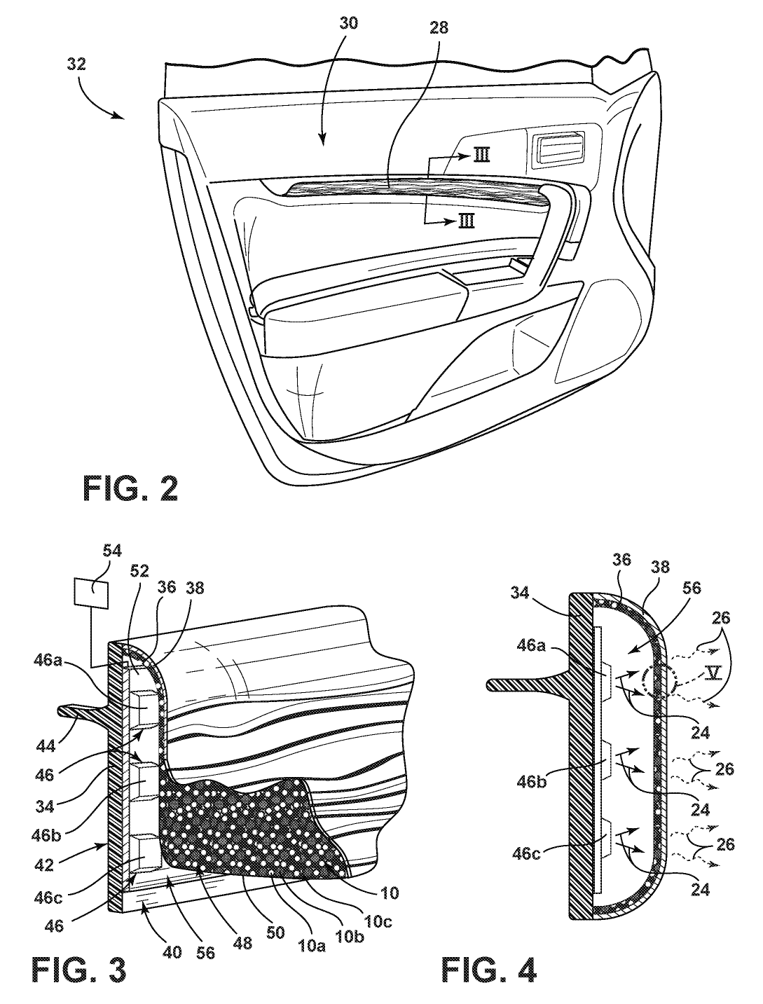

For purposes of description herein, the terms “upper,” “lower,” “right,” “left,” “rear,” “front,” “vertical,” “horizontal,” and derivatives thereof shall relate to the invention as oriented in FIG. 2. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As required, detailed embodiments of the present invention are disclosed herein. However, it is to be understood that the disclosed embodiments are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The following disclosure describes a trim member. The trim member may advantageously employ one or more phosphorescent and/or photoluminescent structures to illuminate in response to predefined events. The one or more photoluminescent structures may be configured to convert ambient light and/or light received from an associated light source and re-emit the light at a different wavelength typically found in the visible spectrum.

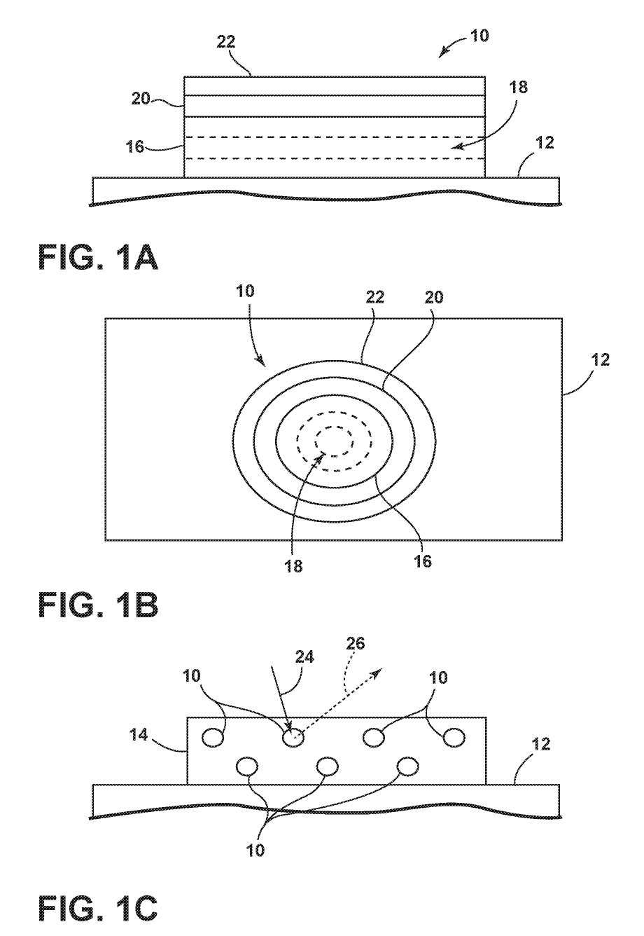

Referring to FIGS. 1A-1C, various exemplary embodiments of photoluminescent structures 10 are shown, each capable of being coupled to a substrate 12, which may correspond to a vehicle fixture or vehicle related piece of equipment. In FIG. 1A, the photoluminescent structure 10 is generally shown rendered as a coating (e.g., a film) that may be applied to a surface of the substrate 12. In FIG. 1B, the photoluminescent structure 10 is generally shown as a discrete particle capable of being integrated with a substrate 12. In FIG. 1C, the photoluminescent structure 10 is generally shown as a plurality of discrete particles that may be incorporated into a support medium 14 (e.g., a film) that may then be applied (as shown) or integrated with the substrate 12.

At the most basic level, a given photoluminescent structure 10 includes an energy conversion layer 16 that may include one or more sublayers, which are exemplarily shown through broken lines in FIGS. 1A and 1B. Each sublayer of the energy conversion layer 16 may include one or more photoluminescent materials 18 having energy converting elements with phosphorescent or fluorescent properties. Each photoluminescent material 18 may become excited upon receiving an excitation light 24 of a specific wavelength, thereby causing the light to undergo a conversion process. Under the principle of down conversion, the excitation light 24 is converted into a longer wavelength, converted light 26 that is outputted from the photoluminescent structure 10. Conversely, under the principle of up conversion, the excitation light 24 is converted into a shorter wavelength light that is outputted from the photoluminescent structure 10. When multiple distinct wavelengths of light are outputted from the photoluminescent structure 10 at the same time, the wavelengths of light may mix together and be expressed as a multicolor light.

Light emitted by a light source 46 (FIG. 3) is referred to herein as excitation light 24 and is illustrated herein as solid arrows. In contrast, light emitted from the photoluminescent structure 10 is referred to herein as converted light 26 and is illustrated herein as broken arrows. The mixture of excitation light 24 and converted light 26 that may be emitted simultaneously is referred to herein as emitted light.

The energy conversion layer 16 may be prepared by dispersing the photoluminescent material 18 in a polymer matrix to form a homogenous mixture using a variety of methods. Such methods may include preparing the energy conversion layer 16 from a formulation in a liquid carrier support medium 14 and coating the energy conversion layer 16 to a desired substrate 12. The energy conversion layer 16 may be applied to a substrate 12 by painting, screen-printing, spraying, slot coating, dip coating, roller coating, and bar coating. Alternatively, the energy conversion layer 16 may be prepared by methods that do not use a liquid carrier support medium 14. For example, the energy conversion layer 16 may be rendered by dispersing the photoluminescent material 18 into a solid-state solution (homogenous mixture in a dry state) that may be incorporated in a polymer matrix, which may be formed by extrusion, injection molding, compression molding, calendaring, thermoforming, etc. The energy conversion layer 16 may then be integrated into a substrate 12 using any methods known to those skilled in the art. When the energy conversion layer 16 includes sublayers, each sublayer may be sequentially coated to form the energy conversion layer 16. Alternatively, the sublayers can be separately prepared and later laminated or embossed together to form the energy conversion layer 16. Alternatively still, the energy conversion layer 16 may be formed by coextruding the sublayers.

In some embodiments, the converted light 26 that has been down converted or up converted may be used to excite other photoluminescent material(s) 18 found in the energy conversion layer 16. The process of using the converted light 26 outputted from one photoluminescent material 18 to excite another, and so on, is generally known as an energy cascade and may serve as an alternative for achieving various color expressions. With respect to either conversion principle, the difference in wavelength between the excitation light 24 and the converted light 26 is known as the Stokes shift and serves as the principle driving mechanism for an energy conversion process corresponding to a change in wavelength of light. In the various embodiments discussed herein, each of the photoluminescent structures 10 may operate under either conversion principle.

Referring back to FIGS. 1A and 1B, the photoluminescent structure 10 may optionally include at least one stability layer 20 to protect the photoluminescent material 18 contained within the energy conversion layer 16 from photolytic and thermal degradation. The stability layer 20 may be configured as a separate layer optically coupled and adhered to the energy conversion layer 16. Alternatively, the stability layer 20 may be integrated with the energy conversion layer 16. The photoluminescent structure 10 may also optionally include a protective layer 22 optically coupled and adhered to the stability layer 20 or other layer (e.g., the conversion layer 16 in the absence of the stability layer 20) to protect the photoluminescent structure 10 from physical and chemical damage arising from environmental exposure. The stability layer 20 and/or the protective layer 22 may be combined with the energy conversion layer 16 through sequential coating or printing of each layer, sequential lamination or embossing, or any other suitable means.

Additional information regarding the construction of photoluminescent structures 10 is disclosed in U.S. Pat. No. 8,232,533 to Kingsley et al., the entire disclosure of which is incorporated herein by reference. For additional information regarding fabrication and utilization of photoluminescent materials to achieve various light emissions, refer to U.S. Pat. No. 8,207,511 to Bortz et al., U.S. Pat. No. 8,247,761 to Agrawal et al., U.S. Pat. No. 8,519,359 to Kingsley et al., U.S. Pat. No. 8,664,624 to Kingsley et al., U.S. Patent Publication No. 2012/0183677 to Agrawal et al., U.S. Pat. No. 9,057,021 to Kingsley et al., and U.S. Pat. No. 8,846,184 to Agrawal et al., all of which are incorporated herein by reference in their entirety.

According to one embodiment, the photoluminescent material 18 may include organic or inorganic fluorescent dyes including rylenes, xanthenes, porphyrins, and phthalocyanines. Additionally, or alternatively, the photoluminescent material 18 may include phosphors from the group of Ce-doped garnets such as YAG:Ce and may be a short persistence photoluminescent material 18. For example, an emission by Ce³⁻ is based on an electronic energy transition from 4D¹ to 4f¹ as a parity allowed transition. As a result of this, a difference in energy between the light absorption and the light emission by Ce³⁺ is small, and the luminescent level of Ce³⁺ has an ultra-short lifespan, or decay time, of 10⁻⁸ to 10⁻⁷ seconds (10 to 100 nanoseconds). The decay time may be defined as the time between the end of excitation from the excitation light 24 and the moment when the light intensity of the converted light 26 emitted from the photoluminescent structure 10 drops below a minimum visibility of 0.32 mcd/m². A visibility of 0.32 mcd/m² is roughly 100 times the sensitivity of the dark-adapted human eye, which corresponds to a base level of illumination commonly used by persons of ordinary skill in the art.

According to one embodiment, a Ce³⁺ garnet may be utilized, which has a peak excitation spectrum that may reside in a shorter wavelength range than that of conventional YAG:Ce-type phosphors. Accordingly, Ce³⁺ has short persistence characteristics such that its decay time may be 100 milliseconds or less. Therefore, in some embodiments, the rare earth aluminum garnet type Ce phosphor may serve as the photoluminescent material 18 with ultra-short persistence characteristics, which can emit the converted light 26 by absorbing purple to blue excitation light 24 emitted from a light source 46. According to one embodiment, a ZnS:Ag phosphor may be used to create a blue converted light 26. A ZnS:Cu phosphor may be utilized to create a yellowish-green converted light 26. A Y₂O₂S:Eu phosphor may be used to create red converted light 26. Moreover, the aforementioned phosphorescent materials may be combined to form a wide range of colors, including white light. It will be understood that any short persistence photoluminescent material known in the art may be utilized without departing from the teachings provided herein. Additional information regarding the production of short persistence photoluminescent materials is disclosed in U.S. Pat. No. 8,163,201 to Kingsley et al. the entire disclosure of which is incorporated herein by reference.

Additionally, or alternatively, the photoluminescent material 18, according to one embodiment, disposed within the photoluminescent structure 10 may include a long persistence photoluminescent material 18 that emits the converted light 26, once charged by the excitation light 24. The excitation light 24 may be emitted from any excitation source (e.g., any natural light source, such as the sun, and/or any artificial light source). The long persistence photoluminescent material 18 may be defined as having a long decay time due to its ability to store the excitation light 24 and release the converted light 26 gradually, for a period of several minutes or hours, once the excitation light 24 is no longer present.

The long persistence photoluminescent material 18, according to one embodiment, may be operable to emit light at or above an intensity of 0.32 mcd/m² after a period of 10 minutes. Additionally, the long persistence photoluminescent material 18 may be operable to emit light above or at an intensity of 0.32 mcd/m² after a period of 30 minutes and, in some embodiments, for a period substantially longer than 60 minutes (e.g., the period may extend 24 hours or longer, and in some instances, the period may extend 48 hours). Accordingly, the long persistence photoluminescent material 18 may continually illuminate in response to excitation from any light source 46 that emits the excitation light 24, including, but not limited to, natural light sources (e.g., the sun) and/or any artificial light source 46. The periodic absorption of the excitation light 24 from any excitation source may provide for a substantially sustained charge of the long persistence photoluminescent material 18 to provide for consistent passive illumination. In some embodiments, a light sensor may monitor the illumination intensity of the photoluminescent structure 10 and actuate an excitation source when the illumination intensity falls below 0.32 mcd/m², or any other predefined intensity level.

The long persistence photoluminescent material 18 may correspond to alkaline earth aluminates and silicates, for example doped di-silicates, or any other compound that is capable of emitting light for a period of time once the excitation light 24 is no longer present. The long persistence photoluminescent material 18 may be doped with one or more ions, which may correspond to rare earth elements, for example, Eu²⁻, Tb³⁺ and/or Dy³. According to one non-limiting exemplary embodiment, the photoluminescent structure 10 includes a phosphorescent material in the range of about 30% to about 55%, a liquid carrier medium in the range of about 25% to about 55%, a polymeric resin in the range of about 15% to about 35%, a stabilizing additive in the range of about 0.25% to about 20%, and performance-enhancing additives in the range of about 0% to about 5%, each based on the weight of the formulation.

The photoluminescent structure 10, according to one embodiment, may be a translucent white color, and in some instances reflective, when unilluminated. Once the photoluminescent structure 10 receives the excitation light 24 of a particular wavelength, the photoluminescent structure 10 may emit any color light (e.g., blue or red) therefrom at any desired brightness. According to one embodiment, a blue emitting phosphorescent material may have the structure Li₂ZnGeO₄ and may be prepared by a high temperature solid-state reaction method or through any other practicable method and/or process. The afterglow may last for a duration of 2-8 hours and may originate from the excitation light 24 and d-d transitions of Mn²⁺ ions.

According to an alternate non-limiting exemplary embodiment, 100 parts of a commercial solvent-borne polyurethane, such as Mace resin 107-268, having 50% solids polyurethane in toluene/isopropanol, 125 parts of a blue green long persistence phosphor, such as Performance Indicator PI-BG20, and 12.5 parts of a dye solution containing 0.1% Lumogen Yellow F083 in dioxolane may be blended to yield a low rare earth mineral photoluminescent structure 10. It will be understood that the compositions provided herein are non-limiting examples. Thus, any phosphor known in the art may be utilized within the photoluminescent structure 10 without departing from the teachings provided herein. Moreover, it is contemplated that any long persistence phosphor known in the art may also be utilized without departing from the teachings provided herein.

Additional information regarding the production of long persistence photoluminescent materials is disclosed in U.S. Pat. No. 8,163,201 to Agrawal et al., the entire disclosure of which is incorporated herein by reference. For additional information regarding long persistence phosphorescent structures, refer to U.S. Pat. No. 6,953,536 to Yen et al., U.S. Pat. No. 6,117,362 to Yen et al., and U.S. Pat. No. 8,952,341 to Kingsley et al., all of which are incorporated herein by reference in their entirety.

Referring to FIGS. 2 and 3, a trim member 28 is disposed within a door panel 30 of a vehicle 32. The trim panel includes an attachment and carrier structure 34 that is configured to attach to a vehicle structure, such as the door panel 30. A decorative layer 36 and/or a protective layer 38 are disposed forwardly of a first side of the attachment and carrier structure 34. A cavity 56 may be formed between the decorative layer 36 and/or the protective layer 38 and a first side 40 the carrier structure 34. On an opposing side 42 of the carrier structure 34, any retaining feature 44 known in the art may be integrally molded onto the carrier structure 34 and/or later attached thereto for attaching the trim member to any desired vehicle structure.

The trim member 28 may confer any aesthetic appearance thereon, such as the wave pattern illustrated in FIG. 3. The aesthetic appearance may be backlit by one or more light sources 46 that are disposed rewardly of and emit light through the decorative layer 36 and/or the protective layer 38. It will be appreciated that the trim member 28 is designed for use in any of a variety of positions in the vehicle 32, including an instrument panel, the door panel 30, a center consoles, an armrests, a cup holder, etc.

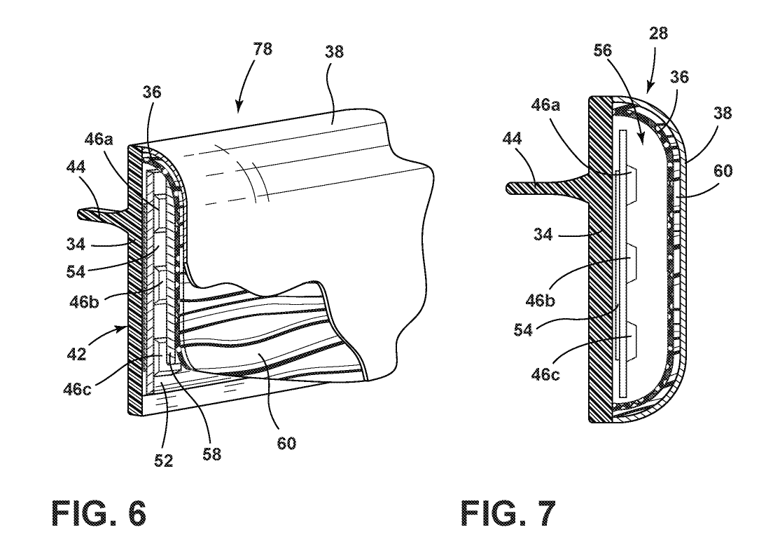

Referring to FIGS. 3 and 4, the decorative layer 36 may be formed into a molded substrate from any practicable transparent and/or translucent material and is contemplated to have one of a variety of possible finishes. For example, the decorative layer 36 may include a variety of metallic appearances, such as chrome, gold, aluminum, etc., with a plethora of possible textured finishes, a darkened or black appearance, a wood grain appearance, etc. The decorative layer 36 may also be a decorative film 60 (FIGS. 6 and 7), fabric, metal, etc.

The decorative layer 36 may include a transparent or translucent material 48 that generally functions to disperse excitation light 24 that is directed toward the translucent material from the one or more light sources 46a, 46b, 46c. According to one embodiment, the decorative layer 36 includes a plurality of beads 50, which may be of varying sizes. For example, the decorative layer 36 may include three sets of variously sized of beads 50.

Further, the beads 50 may be disposed in a plurality of sets that include one or more photoluminescent structures 10 therein that are configured to luminesce in response to receiving excitation light 24 of a predefined wavelength. For example, the decorative layer 36 may include three sets of beads 50 including various photoluminescent structures 10a, 10b, 10c within the beads 50. Accordingly, when a first light source 46a illuminates at a first wavelength, the beads 50 containing the first photoluminescent structure 10a may luminesce in a first color (e.g., light blue). When a second light source 46b illuminates, the beads 50 containing the second photoluminescent structure 10b may luminesce in a second color (e.g., medium blue). When a third light source 46c is illuminated, the beads 50 containing the third photoluminescent structure 10c may luminesce in a third color (e.g., dark blue). Moreover, additional light sources 46 and corresponding photoluminescent structures 10a, 10b, 10c may be disposed within the trim member 28 to provide ambient lighting in one or more colors in addition to, or alternatively of, the photoluminescent structures 10a, 10b, 10c and light sources 46a, 46b, 46c discussed in relation to FIGS. 3 and 4.

The protective layer 38, or laminate, is positioned over the decorative layer 36 any may protect the decorative layer 36 from damage and wear during use. The protective layer 38 may also protect the trim member 28 from the environmental containments, such as dirt and water that may come in contact with the interior of the vehicle 32. The protective layer 38 may be formed of any practicable transparent and/or translucent material known in the art.

Referring once again to FIGS. 3 and 4, the trim member 28 is further illustrated having three light sources 46a, 46b, 46c. The light sources 46a, 46b, 46c may include any form of light source. For example, fluorescent lighting, light emitting diodes (LEDs), organic LEDs (OLEDs), polymer LEDs (PLEDs), solid-state lighting, or any other form of lighting configured to emit light may be utilized. According to one embodiment, some or all of the light sources 46a, 46b, 46c may be configured to emit a wavelength of excitation light 24 that is characterized as ultraviolet light (˜10-400 nanometers in wavelength), violet light (˜380-450 nanometers in wavelength), blue light (˜450-495 nanometers in wavelength), and/or infrared light (IR) (˜700 nm-1 mm in wavelength) to take advantage of the relative low cost attributable to those types of LEDs. In alternate embodiments, the light sources 46 may be disposed or oriented in any other configuration within the trim member 28 without departing from the scope of the present disclosure.

The light sources 46a, 46b, 46c may be disposed on a printed circuit board (PCB) 52 that is operably coupled with a controller 54 having control circuitry including LED drive circuitry for controlling activation and deactivation of the light sources 46a, 46b, 46c. The PCB 52 may be any type of circuit board including, but not limited to, any flexible PCB and/or rigid PCB. Moreover, the controller 54 may be disposed externally from the trim member 28, as illustrated in FIG. 3, or within the cavity 56, as illustrated in FIG. 6, and/or any other desired location.

In operation, any of the light sources 46a, 46b, 46c may be configured to emit excitation light 24 at various wavelengths towards beads 50 containing various photoluminescent structures 10a, 10b, 10c such that the beads 50 containing various photoluminescent structures 10a, 10b, 10c individually luminesce in response to receiving the excitation light 24 of a particular wavelength. The light source 46 may extend along a substantial longitudinal and/or latitudinal portion of the carrier structure 34 and be configured to progressively emit excitation light 24 along the trim member 28 thereby causing at least one of the photoluminescent structures 10a, 10b, 10c to progressively luminesce along the trim member 28.

In some embodiments, some of the light sources 46 may emit non-visible excitation light 24 while additional light sources 46 within the trim member 28 may emit light in the visible spectrum. For example, some, or all, of the light sources 46 disposed within the trim member 28 may be configured as unicolor or multicolored light sources 46. Accordingly, some embodiments of the trim member 28 described herein, may not include the photoluminescent structures 10a, 10b, 10c.

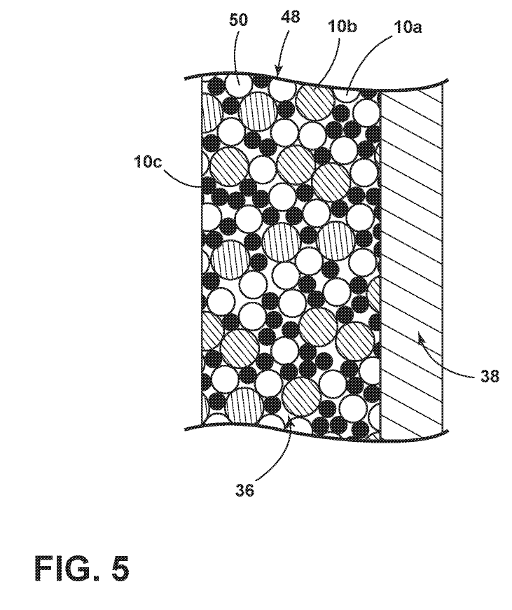

Referring to FIG. 5, the beads 50 may be formed from a glass material, a polymeric material, and/or any other practicable material. In some embodiments, a portion of the beads 50 may be a first material (e.g., a glass) and a second portion of the beads 50 may be a second material (e.g., a polymeric material). The beads 50 may have a solid construction, or may be hollow. In embodiments where the beads 50 have a hollow core, the internal void may include any type of material, solid, liquid, or gas, without departing from the teachings provided herein. It will be appreciated that in alternate embodiments, materials other than beads 50 may be utilized within the decorative layer 36 without departing from the teachings provided herein.

According to one embodiment, the beads 50 may have varying color pigments and/or a different molecular weights that create variations in the refractive index or the respective beads 50. The beads 50 may have a substantially spherical shape, an oblong shape, an irregular shape, or combinations thereof. The beads 50 may range in size from about 60 μm (0.0024 inches) to about 850 μm (0.034 inches). The bead size may be expressed in terms of U.S. Sieve number, or the size of mesh screen that a bead will pass through. For example, a U.S. Sieve Number 20 will permit beads 50 with a diameter of 840 μm (0.033 inches) or less to pass through the mesh, whereas a Number 200 mesh will allow those beads 50 of 74 μm (0.0029 inches) or less to pass. According to one embodiment, the beads 50 may be chosen from 20 to 200 U.S. Sieve Number. The beads 50, according to one embodiment, may be configured in a variety of sizes and/or shapes that are randomly distributed within the decorative layer 36. According to an alternate embodiment, the beads 50 are substantially mono dispersed in size and/or shape.

The decorative layer 36 may contain over 10, 100 or 1000 beads 50 per square inch that are bonded within the decorative layer 36. The transparency of the beads 50 may allow excitation light 24 to pass into the beads 50 thereby causing the beads 50 to luminesce. The luminescence exhibited may be in predefined patterns, such as a wave pattern, that is visible thorough the protective layer 38 in the illuminated and/or unilluminated state.

The beads 50 may be applied in a premixed solution and disposed into the wet decorative layer 36, dropped onto a premixed two-part epoxy or thermoplastic material, and/or through any other process known in the art. According to one embodiment, selectively located injection gates disperse the beads 50 in a desired path to create the wave pattern, or any other desired pattern within the decorative layer 36. According to an alternate embodiment, the beads 50 are disposed in a single hopper and are randomly disposed within the decorative layer 36. Alternatively still, a multishot molding process may be used that disposes multiple layer of beads 50 on one another to form the decorative layer 36. In any manner of deposition, the beads 50 may be disposed in a unique pattern on each separately manufactured trim member 28 such that each trim member 28 may have unique decorative appearances when assembled on the vehicle 32.

Referring to FIGS. 6 and 7, an alternate embodiment of the trim member 28 is illustrated. As illustrated, the trim member 28 includes a light guide 58 that is disposed between the light sources 46a, 46b, 46c and the decorative layer 36. The light guide 58 may be made of a clear thermoplastic material, such as an acrylic material, or any other transparent and/or translucent material. The light guide 58 may be a substantially transparent or translucent guide suitable for transmitting light. The light guide 58 may be formed from a rigid material that is comprised of a curable substrate such as a polymerizable compound, a mold in clear (MIC) material and/or mixtures thereof. Acrylates are also commonly used for forming rigid light pipes, as well as poly-methyl methacrylate (PMMA), which is a known substitute for glass. A polycarbonate material may also be used in an injection molding process to form the rigid light guide 58.

Further, the light guide 58 may be a flexible light guide, wherein a suitable flexible material is used to create the light guide 58. Such flexible materials include urethanes, silicone, thermoplastic polyurethane (TPU), or any other like optical grade flexible materials. Whether the light guide 58 is flexible or rigid, the light guide 58, when formed, is substantially optically transparent and/or translucent and capable of transmitting light. The light guide 58 may be referred to as a light pipe, a light plate, a light bar or any other light carrying or transmitting substrate made from a clear or substantially translucent material.

The light guide 58 may be held in place through any means known in the art. For example, the light guide 58 may include locators that correspond to locator apertures defined by the PCB 52. Additionally, and/or alternatively, the light guide 58 may be compressively, adhesively, fastened, or otherwise disposed between the decorative layer 36 and the PCB 52.

With further reference to FIGS. 6 and 7, the trim member 28 further may include a film 60 that is configured to further define a pattern or image through the protective layer 38 of the member. For example, the film 60 may include any desired pattern thereon, may have a photoluminescent structure 10 printed thereon, and/or include light bending characteristics (e.g., act as a diffusive layer). Alternatively, the film 60 may be configured to confer a metallic appearance to through the decorative layer 36 and/or protective layer 38. The metallic appearance can be disposed on the film 60 and/or within the film 60 through any method known in the art, including, but not limited to, sputter deposition, vacuum deposition (vacuum evaporation coating), electroplating, or directly printed onto the film 60 by a computer printer after preparation of the desired pattern through a computer. The metallic appearance may be chosen from a wide range of reflective materials and/or colors, including, but not limited to, silver, chrome, copper, bronze, gold, or any other metallic surface. Additionally, an imitator of any metallic material may also be utilized without departing from the teachings provided herein.

In other embodiments, the film 60 may be tinted any color to complement the vehicle structure on which the trim member 28 is to be received. In any event, the film 60 should be at least partially light transmissible such that the converted light 26 is not prevented from illuminating therethrough whenever an energy conversion process is underway.

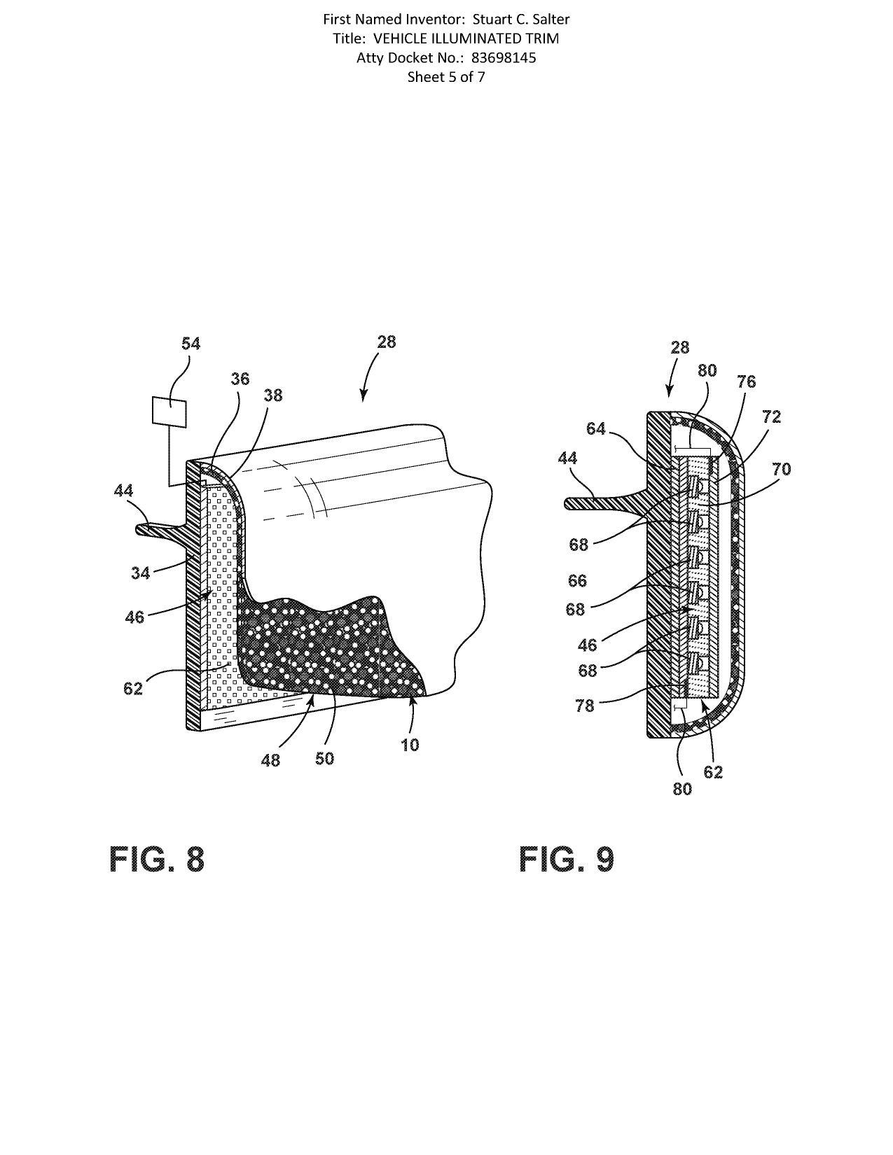

Referring to FIGS. 8 and 9, the light source 46 may have a stacked arrangement that includes a light-producing assembly 62. The light-producing assembly 62 may correspond to a thin-film or printed light emitting diode (LED) assembly and includes a base member 64 as its lowermost layer. The base member 64 may include a polycarbonate, poly-methyl methacrylate (PMMA), or polyethylene terephthalate (PET) material, or any other material known in the art, on the order of 0.005 to 0.060 inches thick and is arranged over the carrier structure 34. Alternatively, as a cost saving measure, the base member 62 may directly correspond to a preexisting vehicle structure (e.g., the carrier structure 34).

The light-producing assembly 62 includes a positive electrode 66 arranged over the base member 64. The positive electrode 66 includes a conductive epoxy such as, but not limited to, a silver-containing or copper-containing epoxy. The positive electrode 66 is electrically connected to at least a portion of a plurality of LED sources 68 arranged within a semiconductor ink 70 and applied over the positive electrode 66. Likewise, a negative electrode 72 is also electrically connected to at least a portion of the LED sources 68. The negative electrode 72 is arranged over the semiconductor ink 70 and includes a transparent or translucent conductive material such as, but not limited to, indium tin oxide. Additionally, each of the positive and negative electrodes 66, 72 are electrically connected to the controller 54 and a power source 74 via a corresponding bus bar 76, 78 and conductive leads 80. The bus bars 76, 78 may be printed along opposite edges of the positive and negative electrodes 66, 72 and the points of connection between the bus bars 76, 78 and the conductive leads 80 may be at opposite corners of each bus bar 76, 78 to promote uniform current distribution along the bus bars 76, 78. It should be appreciated that in alternate embodiments, the orientation of components within the light-producing assembly 62 may be altered without departing from the concepts of the present disclosure. For example, the negative electrode 72 may be disposed below the semiconductor ink 70 and the positive electrode 66 may be arranged over the aforementioned semiconductor ink 70. Likewise, additional components, such as the bus bars 76, 78 may also be placed in any orientation.

The LED sources 68 may be dispersed in a random or controlled fashion within the semiconductor ink 70 and may be configured to emit focused or non-focused light toward the decorative layer 36. The LED sources 68 may correspond to micro-LEDs of gallium nitride elements on the order of about 5 to about 400 microns in size and the semiconductor ink 70 may include various binders and dielectric material including, but not limited to, one or more of gallium, indium, silicon carbide, phosphorous, and/or translucent polymeric binders.

The semiconductor ink 70 can be applied through various printing processes, including ink jet and silk screen processes to selected portion(s) of the positive electrode 66. More specifically, it is envisioned that the LED sources 68 are dispersed within the semiconductor ink 70, and shaped and sized such that a substantial quantity of the LED sources 68 align with the positive and negative electrodes 66, 72 during deposition of the semiconductor ink 70. The portion of the LED sources 68 that ultimately are electrically connected to the positive and negative electrodes 66, 72 may be illuminated by a combination of the bus bars 76, 78, the controller 54, power source 74, and conductive leads 80. According to one embodiment, the power source 74 may correspond to a vehicular power source 74 operating at 12 to 16 VDC. Additional information regarding the construction of light-producing assemblies is disclosed in U.S. Patent Publication No. 2014/0264396 member 64 to Lowenthal et al. the entire disclosure of which is incorporated herein by reference.

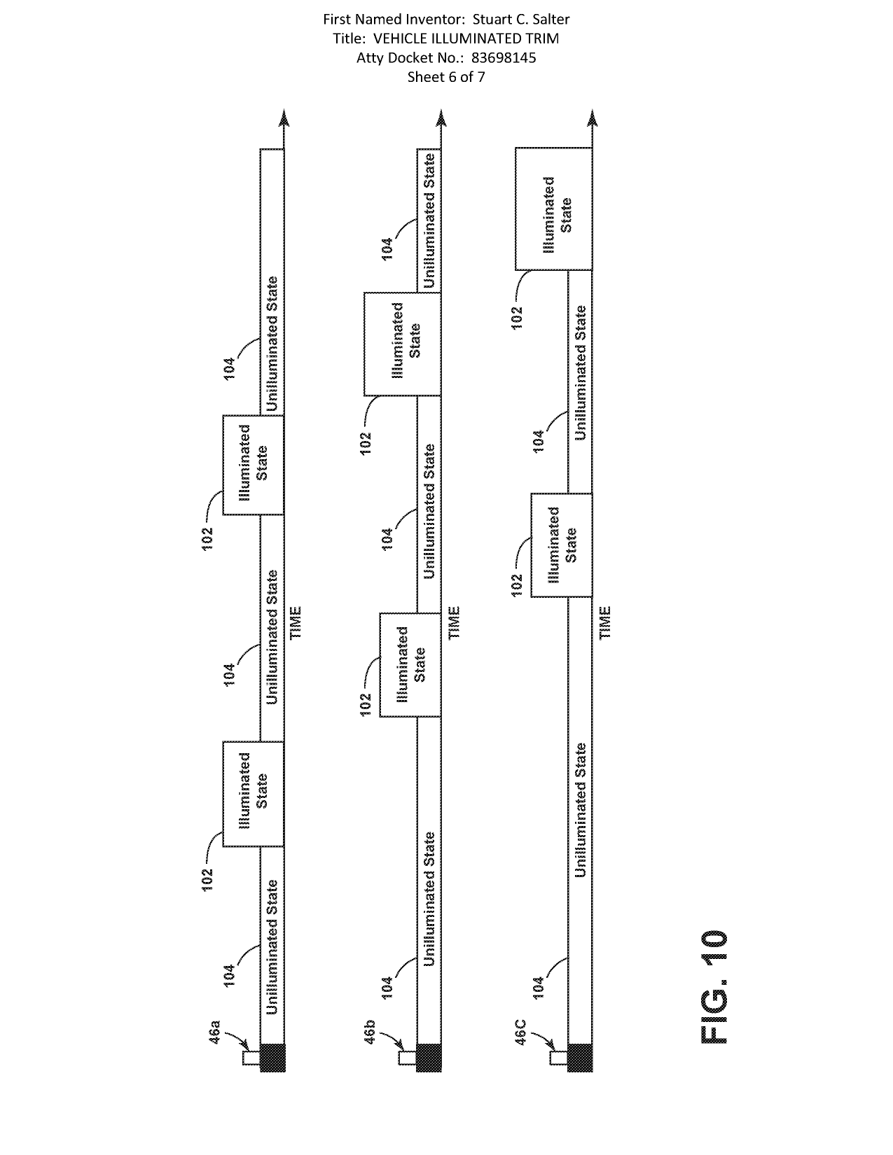

Referring to FIG. 10, the illumination sequences of three independently illuminable light sources 46a, 46b, 46c are schematically illustrated. For illustrative purposes, the illumination states of each light source 46a, 46b, 46c are shown as rectangles 102 of varying sizes. The length of each illuminated state rectangle exemplifies the illumination period of each light source 46a, 46b, 46c. The height of each illuminated state rectangle exemplifies the intensity of light emitted from the light source 46a, 46b, 46c. Unilluminated state rectangles 104 are disposed between each of the illuminated state rectangles 102 and illustrate time periods in which each respective light source 46a, 46b, 46c is in an unilluminated state. Moreover, as described above, the light sources 46 may each illuminate in a wide range of randomly generated colors in some embodiments. Additional information regarding the illumination patterns for light sources 46 disposed within vehicles is disclosed in U.S. patent application Ser. No. 15/151,543 to Salter et al., the entire disclosure of which is incorporated herein by reference.

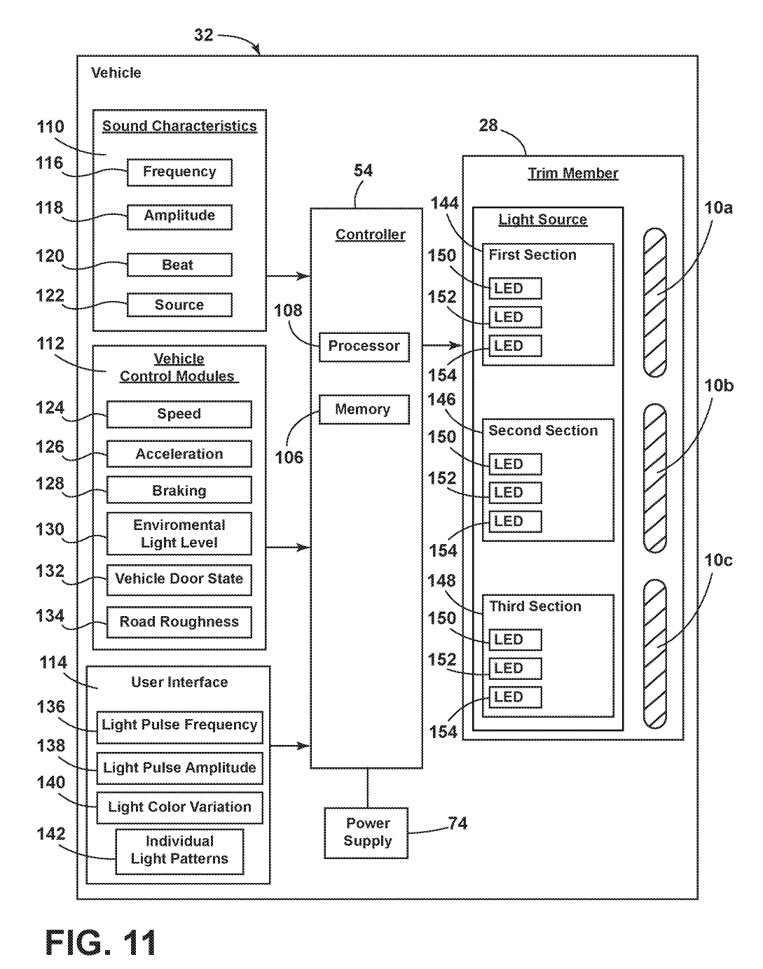

Referring to FIG. 11, a block diagram of the vehicle 32 is generally shown in which the trim member 28 is implemented. The vehicle 32 includes the controller 54 in communication with the light source 46. The controller 54 may include memory 106 having instructions contained therein that are executed by a processor 108 of the controller 54. The controller 54 may provide electrical power to the light source 46 via a power source 74 located onboard the vehicle 32. In addition, the controller 54 may be configured to control the excitation light 24 based on feedback received from one or more inputs.

The inputs that effect the illumination of the trim member 28 may include sound characteristics 110 from an audio system, information provided by vehicle control modules 112, and/or trim member 28 illumination settings that may be inputted through a user interface 114. The sound characteristics 110 include frequency 116, amplitude 118, beat 120, and source 122 of inputted sounds. According to one embodiment, the wavelength of excitation light 24 emitted from the light source 46 varies as the frequency 116 and/or amplitude 118 of sound changes. Further, the beat 120 may also affect the color generation from the trim member 28. The trim member 28 may illuminate in a first color when music from the audio system is playing and may illuminate in a second color to provide additional information to an occupant of the vehicle 32. For example, the trim member 28 may illuminate in a second color when a navigation unit within the vehicle 32 is providing directional commands to the occupant and then may return to the first color when the directional command is finished.

Vehicle control modules 112 such as, but not limited to, a body control module, engine control module, steering control module, brake control module, the like, or a combination thereof may also vary the colors of the trim member 28. By controlling the excitation light 24 emitted from the light source 46, the trim member 28 may illuminate in a variety of colors and/or patterns to provide an aesthetic appearance, or may provide vehicle information to an intended observer. For example, the trim member 28 may luminesce in various colors as the speed 124 and/or acceleration 126 of the vehicle 32 is varied. Also, the trim member 28 may be utilized in conjunction with the vehicle braking system 128 to provide additional illumination during a braking period. Additionally, or alternatively, the trim member 28 may also illuminate in a desired color, such as red, when the vehicle 32 approaches another object at a rapid speed to warn the occupants of the upcoming object.

The ambient light level 130 outside the vehicle 32 may also affect the lighting of the trim member 28. For example, the trim member 28 may illuminate at a higher intensity during the day and a lower intensity during low light conditions. Also, as described above, the trim member 28 may illuminate in a desired color to inform an occupant of a specific vehicle condition, such as a vehicle door state 132 (e.g., the door being disposed in an ajar position). Or, the trim member 28 may vary in color with changes in environmental conditions, such as road roughness 134, potential hazards, variations in weather, or for any other reason.

The vehicle 32 may also include a user interface 114 that an occupant may utilize for setting desired lighting effects of the trim member 28. The user interface 114 may be an independent system, or integrated into any other system, such as a human machine interface (HMI), of the vehicle 32. The user interface 114 may be configured such that a user may control the wavelength of excitation light 24 that is emitted by the light source 46 or a pattern of illumination. For example, an occupant may control the light pulse frequency 136, light pulse amplitude 138, light color variations 140, and/or individual light patterns 142 through usage of the user interface 114.

In operation, the light source 46 may include one or more sections 144, 146, 148 each containing one or more LEDs 150, 152, 154 therein that may emit excitation light 24 of varying wavelengths, as provided herein. In response, the photoluminescent structures 10a, 10b, 10c may exhibit periodic unicolor or multicolor illumination. Additionally, each section 144, 146, 148 may independently illuminate the LEDs 150, 152, 154 within that section 144, 146, 148 to provide dynamically illuminated patterns within and/or along the trim member 28. The LEDs 150, 152, 154 may each correspond with a respective photoluminescent structure 10a, 10b, 10c such that the luminescence exhibited by the trim member 28 is a direct correlation of the LEDs 150, 152, 154 that are illuminated.

With respect to the above examples, the controller 54 may modify the intensity of the emitted wavelengths of excitation light 24 by pulse-width modulation or current control. In some embodiments, the controller 54 may be configured to adjust a color of the excitation light 24 by sending control signals to adjust an intensity or energy output level of the light source 46. For example, if the light source 46 is configured to output the first wavelength at a low level, substantially all of the first wavelength may be converted to the second wavelength by the one or more photoluminescent structures 10a, 10b, 10c. If the light source 46 is configured to output the first wavelength (i.e., excitation light 24) at a high level, only a portion of the first wavelength may be converted to the second wavelength (i.e., converted light 26). In this configuration, a color of light corresponding to mixture of the first wavelength and the second wavelength may be output as the emitted light. In this way, the controller 54 may control an output color of the emitted light.

Though a low level and a high level of intensity are discussed in reference to the first wavelength of excitation light 24, it shall be understood that the intensity of the first wavelength of excitation light 24 may be varied among a variety of intensity levels to adjust a hue of the color corresponding to the emitted light from the trim member 28. The variance in intensity may be manually altered, or automatically varied by the controller 54 based on predefined conditions.

As described herein, the color of the converted light 26 may be significantly dependent on the particular photoluminescent materials 18 utilized in the photoluminescent structures 10a, 10b, 10c. Additionally, a conversion capacity of the photoluminescent structures 10a, 10b, 10c may be significantly dependent on a concentration of the photoluminescent material 18 utilized in the photoluminescent structures 10a, 10b, 10c. By adjusting the range of intensities that may be output from the light source 46, the concentration, types, and proportions of the photoluminescent materials 18 in the photoluminescent structures 10a, 10b, 10c discussed herein may be operable to generate a range of color hues of the emitted light by blending the first wavelength with the second wavelength.

A variety of advantages may be derived from the use of the present disclosure. For example, use of the disclosed trim member provides a unique aesthetic appearance to the vehicle. Moreover, the trim member may provide additional visual information to the occupants of the vehicle. Lastly, through the usage of multiple light sources and/or multiple photoluminescent structure, a wide array of patterns and appearances may be conferred by the trim member.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

Furthermore, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited, to physically mateable and/or physically interacting components and/or wirelessly interactable and/or wirelessly interacting components and/or logically interacting and/or logically interactable components.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A trim member for a vehicle comprising:
a carrier structure;
a decorative layer coupled to the carrier structure forming a cavity therebetween;
a first plurality of beads disposed within the decorative layer containing a first photoluminescent structure therein;
a second plurality of beads disposed within the decorative layer containing a second photoluminescent structure therein; and
a light source, wherein the first and second photoluminescent structures independently luminesce in response to an excitation light emitted by the light source.

2. The trim member for a vehicle of claim 1, wherein the excitation light comprises at least one of blue light, violet light, infrared and UV light.

3. The trim member for a vehicle of claim 2, wherein the first photoluminescent structure and the second photoluminescent structure each include at least one photoluminescent material therein configured to convert the excitation light received from the light source into a visible converted light.

4. The trim member for a vehicle of claim 1, wherein the first and second pluralities of beads are of various sizes.

5. The trim member for a vehicle of claim 4, wherein the first and second pluralities of beads are disposed within the decorative layer in a predefined pattern.

6. The trim member for a vehicle of claim 1, wherein the first and second pluralities of beads within the decorative layer are randomly disposed within the decorative layer.

7. A trim member comprising:
a carrier structure coupled to a decorative layer forming a cavity therebetween;
a first set of beads disposed within the decorative layer containing a first photoluminescent structure therein; and
a light source extending a substantial portion of the carrier structure and configured to progressively emit excitation light thereby causing the first photoluminescent structure to progressively luminesce along the trim member.

8. The trim member of claim 7, wherein the excitation light comprises at least one of blue light, violet light, infrared and UV light.

9. The trim member of claim 7, wherein the first photoluminescent structure and the second photoluminescent structure each include at least one photoluminescent material therein configured to convert the excitation light received from the light source into a visible converted light.

10. The trim member of claim 7, further comprising:
a second set of beads disposed within the decorative layer containing a second photoluminescent structure therein.

11. The trim member of claim 10, wherein the first and second sets of beads are interspersed such that a predefined pattern is formed.

12. The trim member of claim 11, wherein the predefined pattern is a wave pattern.

13. The trim member of claim 7, wherein the first and second photoluminescent structures may independently luminesce in response to excitation light emitted by the light source.

14. The trim member of claim 7, wherein the light source is configured as a light-producing assembly extending along the carrier structure.

15. A trim member for a vehicle comprising:
a carrier structure;
a decorative layer coupled to the carrier structure forming a cavity therebetween;
a plurality of beads disposed within the decorative layer, the plurality of beads containing first and second photoluminescent structures therein; and
a light source having a plurality of LEDs that cause the first and second photoluminescent structures to independently luminesce in response to an excitation light emitted by the light source.

16. The trim member for a vehicle of claim 15, further comprising:
a light transmissive protective layer disposed on the decorative layer.

17. The trim member for a vehicle of claim 15, further comprising:
a light guide disposed between the light source and the decorative layer.

18. The trim member for a vehicle of claim 16, further comprising:
a film disposed between the decorative layer and the protective layer.

19. The trim member for a vehicle of claim 15, wherein the light source includes a plurality of LEDs that illuminate at offset intervals.

20. The trim member for a vehicle of claim 19, wherein the light source illumination is varied based on at least one of a sound characteristic, a vehicle control module, or a user interface.
